(19) United States
(12) Patent Application Publication
(10) Pub. No.: US 2025/0043064 A1
(43) Pub. Date: Feb. 6, 2025

(54) AMINOSILANE MODIFIED TACKIFIER AND PREPARATION METHOD THEREFOR, AND HIGH-WATER-RESISTANCE SILANE MODIFIED POLYETHER ADHESIVE AND PREPARATION METHOD THEREFOR

(71) Applicants: GUANGZHOU BAIYUN TECHNOLOGY CO., LTD., Guangdong (CN); GUANGDONG BAIYUN TECHNOLOGY CO., LTD., Guangdong (CN)

(72) Inventors: Jianjun CHEN, Guangdong (CN); Yangqing CHEN, Guangdong (CN); Hengchao HUANG, Guangdong (CN); Mingsong MIAO, Guangdong (CN); Minhua GAO, Guangdong (CN); Hua TANG, Guangdong (CN)

(73) Assignees: GUANGZHOU BAIYUN TECHNOLOGY CO., LTD., Guangdong (CN); GUANGDONG BAIYUN TECHNOLOGY CO., LTD., Guangdong (CN)

(21) Appl. No.: 18/915,355

(22) Filed: Oct. 15, 2024

Related U.S. Application Data
(63) Continuation of application No. PCT/CN2022/141321, filed on Dec. 23, 2022.

(30) Foreign Application Priority Data
Apr. 19, 2022 (CN) 202210410823.6

(51) Int. Cl. C08G 59/40; C08G 59/32; C08G 59/70; C08K 3/26; C08K 5/00; C08K 5/5425; C09J 171/02

(52) U.S. Cl. CPC C08G 59/4085; C08G 59/32; C08G 59/70; C08K 3/26; C08K 5/0016; C08K 5/5425; C09J 171/02; C08K 2003/265; C08K 2201/011

(57) ABSTRACT

Disclosed are an aminosilane modified tackifier and a preparation method therefor, and a silane modified polyether adhesive and a preparation method therefor. The aminosilane modified tackifier has the following structure. The aminosilane modified tackifier is added in the silane modified polyether adhesive of the present disclosure, such that the silane modified polyether adhesive has high adhesion property with a base material, particularly high water-soaking adhesion property, and meanwhile has high comprehension properties such as high displacement capability, high elasticity recovery rate and high cohesion strength, and thus has significant advantages compared with the existing products in the market.

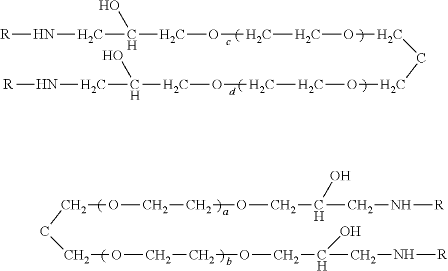

### CROSS-REFERENCE TO RELATED APPLICATION

This application is a continuation of international application of PCT application serial no. PCT/CN2022/141321, filed on Dec. 23, 2022, which claims the priority benefit of China application no. 202210410823.6 on Apr. 19, 2022. The entirety of each of the above-mentioned patent applications is hereby incorporated by reference herein and made a part of this specification.

### BACKGROUND

### Technical Field

The present disclosure relates to the field of sealant, and in particular to an aminosilane modified tackifier and preparation method therefor, and a high-water-resistance silane modified polyether adhesive and preparation method therefor.

### Description of Related Art

Prefabricated buildings have many advantages such as high construction efficiency, low resource and energy consumption, less environmental pollution, fewer on-site construction personnel, and high turnover rate of funds and equipments. In recent years, they have developed rapidly in China. During the assembly process of prefabricated components in prefabricated buildings, there are a large number of joints that require waterproof sealant treatment, especially for exterior wall joints. Sealant is the first line of defense for waterproof-sealant, and its performance will directly affect the waterproof-sealant effect, which is crucial to the quality of the house. Prefabricated building sealant is different from traditional building sealant. The joints of prefabricated building exterior walls would undergo displacement changes under the effects of thermal expansion and contraction of prefabricated components, wind pressure, foundation settlement, etc., causing the sealant to be subjected to tensile, compressive, shear and other forces, resulting in the risk of delamination and cracking. Therefore, low-modulus and high displacement sealant products are needed. According to the requirements for waterproof sealant of joints in prefabricated buildings, the most commonly used is 25 LM single-component and low-modulus silane modified polyether adhesive.

Sealant for prefabricated building needs to undergo long-term exposure to sunlight and rain, and is required to have excellent water-resistance (water-immersion or water-soaking performance). However, the available single-component silane modified polyether adhesives for prefabricated buildings are tested according to existing standards such as JC/T 881-2017 and GB/T 14683-2017. The requirements are relatively low, for example, no damage of the tensile adhesion after water-soaking for 4 days. Many products have poor actual water-resistance. In addition, there is still significant space for improvement in displacement ability, elastic recovery rate, and cohesive strength of available single component low-modulus silane modified polyether adhesives, which have a significant impact on the waterproof sealant effect and durability of prefabricated buildings. Therefore, it is very necessary to adopt new technological to improve the comprehensive performance such as water-resistance and displacement ability of single-component silane modified polyether adhesives for prefabricated building.

### SUMMARY

To overcome the shortcomings of existing technology, it is necessary to provide a low-modulus silane modified polyether adhesive with high water-soaking adhesion property and high displacement ability, and preparation method therefor. Based on this, the present disclosure synthesizes an aminosilane modified tackifier with a multi-claw structure containing polyether segments. The aminosilane modified tackifier can significantly improve the adhesion between the silane modified polyether adhesive and the base material, especially the water-soaking adhesion property, as well as displacement ability, elastic recovery rate, and cohesive strength of the silane modified polyether adhesive, and thus has significant advantages compared with the available products in the market.

The specific technical solutions include the following.

An aminosilane modified tackifier with a following structure:

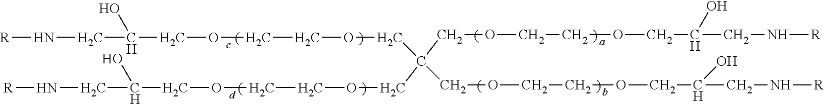

wherein, 1≤a≤15, 1≤b≤15, 1≤c≤15, 1≤d≤15, 4≤a+b+c+d≤40;
R is a residue of an aminosilane coupling agent after removing an amino group.

An aminosilane modified tackifier is obtained by reacting an epoxy terminated polyether with an aminosilane coupling agent; the epoxy terminated polyether has a following structure:

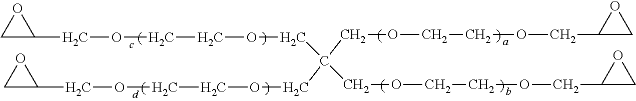

wherein, 1≤a≤15, 1≤b≤15, 1≤c≤15, 1≤d≤15, 4≤a+b+c+d≤40.

In some embodiments, the aminosilane coupling agent is selected from at least one of γ-aminopropyltrimethoxysilane (KH540), γ-aminopropyltriethoxysilane (KH550), and 3-aminopropylmethyldimethoxysilane.

In some embodiments, the molar ratio of the epoxy group in the epoxy terminated polyether to the amino group in the aminosilane coupling agent is 1:1.2 to 1:1.5.

The present disclosure also provides a method for preparing the aminosilane modified tackifier, including the following technical solution.

A method for preparing the aminosilane modified tackifier, comprises the following steps: reacting the epoxy terminated polyether with the aminosilane coupling agent at a reaction temperature of 25° C. to 50° C. for a reaction time of 40 minutes to 1.5 hours to obtain the aminosilane modified tackifier.

In some embodiments, the reaction temperature is 35° C. to 45° C. and the reaction time is 55 minutes to 65 minutes.

The present disclosure also provides a silane modified polyether adhesive, which has high adhesion property to the base material, particularly high water-soaking adhesion property, and meanwhile has high comprehensive properties such as high displacement capability, high elasticity recovery rate and high cohesion strength, and thus has significant advantages compared with the existing products in the market, including the following technical solution.

A silane modified polyether adhesive, is prepared from raw materials including a silane modified polyether polymer and the aminosilane modified tackifier.

In some embodiments, the mass percentage of the aminosilane modified tackifier in the silane modified polyether adhesive is 1% to 5%.

In some embodiments, the silane modified polyether adhesive is prepared from raw materials comprising the following components in parts by weight:
15 to 45 parts of the silane modified polyether polymer;
1 to 5 parts of the aminosilane modified tackifier;
20 to 60 parts of a reinforcing filler;
10 to 40 parts of a plasticizer;
0.5 to 5 parts of a thixotropic agent;
0.5 to 4 parts of a water removal agent; and
0.1 to 3 parts of catalyst.

In some embodiments, the silane modified polyether polymer is a polymer with structures shown in formula (I) and/or formula (II):

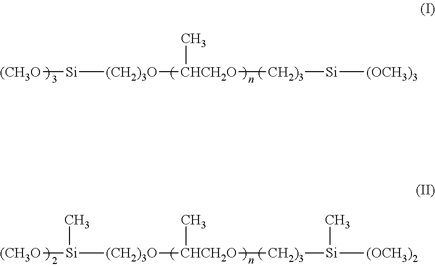

In some embodiments, the silane modified polyether polymer has a viscosity of 6 Pa·s to 82 Pa·s at 25° C.

In some embodiments, the reinforcing filler is selected from at least one of nano-active calcium carbonate, silica micro-powder, and heavy calcium carbonate or tale powder.

In some embodiments, the plasticizer is selected from at least one of dioctyl phthalate, diisodecyl phthalate, diisononyl phthalate, dibutyl phthalate, dioctyl adipate, diisodecyl adipate, dioctyl sebacate, diisooctyl sebacate, diphenyl octyl phosphate, cresyl diphenyl phosphate, and polypropylene glycol.

In some embodiments, the thixotropic agent is selected from at least one of polyamide wax, hydrogenated castor oil, organic bentonite, and gas-phase white carbon black.

In some embodiments, the water removing agent is selected from at least one of vinyltrimethoxysilane, vinyltriethoxysilane, and vinylmethyldimethoxysilane,

In some embodiments, the catalyst is selected from at least one of dibutyltin diacetate, dibutyltin dilaurate, dioctyltin diacetate, stannous octoate, and di-n-butylbis (acetylacetonate)-tin.

In some embodiments, the silane modified polyether adhesive is prepared from raw materials comprising the following components in parts by weight:
28 to 32 parts of the silane modified polyether polymer;
2.5 to 3.5 parts of the aminosilane modified tackifier;
40 to 46 parts of nano-active calcium carbonate;
18 to 22 parts of PPG3000;
0.8 to 1.2 parts of polyamide wax;
2 to 3 parts of vinylmethyldimethoxysilane; and
0.2 to 1 part of di-n-butylbis (acetylacetonate) tin;
a structural formula of the silane modified polyether polymer is:

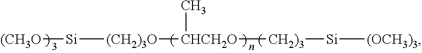

and its viscosity at 25° C. is 20 Pa·s;
a structural formula of the aminosilane modified tackifier is:

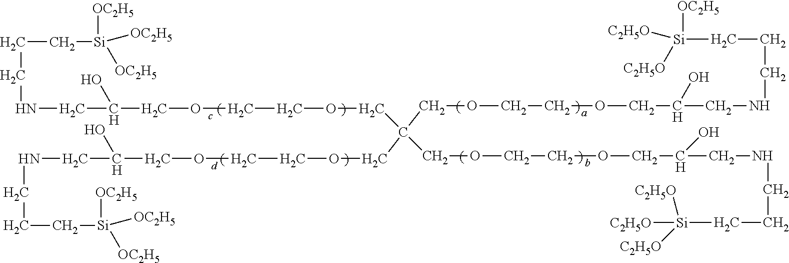

wherein, 1≤a≤15, 1≤b≤15, 1≤c≤15, 1≤d≤15, 4≤a+b+c+d≤40.

The present disclosure also provides a method for preparing the above-mentioned silane modified polyether adhesive, including the following technical solution.

A method for preparing the silane modified polyether adhesive, comprising the following steps:

mixing and stirring the silane modified polyether polymer, reinforcing filler, the thixotropic agent, and the plasticizer evenly, then adding the water removal agent, stirring evenly, and then adding the aminosilane modified tackifier and the catalyst, stirring evenly under a vacuum condition to obtain the silane modified polyether adhesive.

In some embodiments, the preparation method of silane modified polyether adhesive comprises the following steps:

mixing and stirring the silane modified polyether polymer, the reinforcing filler, the thixotropic agent, and the plasticizer evenly for 20 minuets to 60 minutes, then adding the water removal agent, stirring evenly for 15 minuets to 30 minutes, and then adding the aminosilane modified tackifier and the catalyst, stirring evenly for 20 minuets to 50 minutes under a vacuum condition of −0.09 MPa to −0.1 MPa to obtain the silane modified polyether adhesive.

The present disclosure synthesizes an aminosilane modified tackifier containing polyether segments with a multi-claw structure. The polyether segments in the aminosilane modified tackifier is similar to the main chain structure of the silane modified polyether adhesive, which is beneficial for improving compatibility with the polyether adhesive system. At the same time, the presence of the polyether segments makes the silane modified polyether adhesive have good flexibility. Compared with traditional silane coupling agents, the aminosilane modified adhesive has more hydrolyzable groups and can better undergo hydrolysis condensation reactions with hydroxyl groups on the surface of the bonded base material, which is beneficial for improving the adhesion between polyether adhesive and base material, especially water-soaking adhesion; the aminosilane modified tackifier has multiple hydrolyzable groups that can also undergo condensation reactions with the silanol groups of silane modified polyether polymers after hydrolysis, which is beneficial for improving the comprehensive properties of silane modified polyether adhesives, such as displacement ability, elastic recovery rate, and cohesive strength. Therefore, compared with the existing technology, the present disclosure has the following beneficial effects:

By adding the aminosilane modified tackifier synthesized by the present disclosure, the silane modified polyether adhesive has high adhesion property with the base material, particularly high water-soaking adhesion property, and meanwhile has high comprehension properties, such as high displacement capability, high elasticity recovery rate and high cohesion strength, and thus has significant advantages compared with the existing products in the market.

### DESCRIPTION OF THE EMBODIMENTS

The technical solution of the present disclosure will be further illustrated through specific embodiments. Technicians in this field should understand that the described embodiments are only intended to help understand the present disclosure and should not be considered as limitations to the present disclosure.

Unless otherwise defined, all technical and scientific terms used in the present disclosure have the same meaning as those commonly understood by those skilled in the art to which the present disclosure belongs. The terms used in the description of the present disclosure are for the purpose of describing specific embodiments only and are not intended to limit the present disclosure.

The terms “including” and “having” in the present disclosure, as well as any variations thereof, are intended to cover non-exclusive inclusions. For example, a process, method, device, product, or equipment that includes a series of steps is not limited to the listed steps or modules, but optionally includes steps that are not listed, or alternatively includes other steps inherent to these processes, methods, products, or devices.

The term “multiple” mentioned in the present disclosure refers to two or more. “And/or” describes the relationship of the associated objects, indicating that there can be three types of relationships. For example, A and/or B can represent: the existence of A alone, the coexistence of A and B, and the existence of B alone. The character “/” generally indicates that the associated objects are in an “or” relationship.

The epoxy terminated polyether described in the present disclosure can be prepared by the following method:
(1) weighing a certain amount of quaternary polyether tetraol (PP150), heating to 100° C. to 120° C. for vacuum dehydration for 0.5 hour to 1 hour, and then cooling to room temperature with dry nitrogen gas; adding catalyst BF₃O(C₂H₅)₂ (boron trifluoride ether complex), with a rate of BF₃O(C₂H₅)₂:PP150=1:100 to 1:150 (by mass), and stirring evenly;
(2) raising the temperature to 55° C. to 70° C., and slowly adding epichlorohydrin dropwise using a constant pressure funnel within 2 hours while stirring; the ratio of epichlorohydrin to PP150 was 1:2 to 1:2.5 (by mass); then, keeping the temperature and reaction for 7 hours to 8 hours, and removing unreacted epichlorohydrin by evacuation;
(3) cooling down to 45° C., diluting the reaction solution with toluene, and adding solid NaOH in multiple portions within 2 hours with a ratio of NaOH:PP150=1:6.5 to 1:7 (by mass); keeping the reaction for 5 hours to 6 hours under heat preservation;
(4) vacuum filtering the reaction solution, collecting the filtrate with a separatory funnel, extracting the organic phase with a toluene, and finally washing with distilled water until neutral;
(5) placing the organic phase in a beaker, and placing the beaker in a 110° C. air drying oven for 7 hours to 8 hours to remove the solvent, and then placing it in a 110° C. vacuum drying oven for 0.5 hour to 1 hour to obtain a low viscosity polymer with good fluidity, namely epoxy terminated polyether. The reaction equation is as follows:

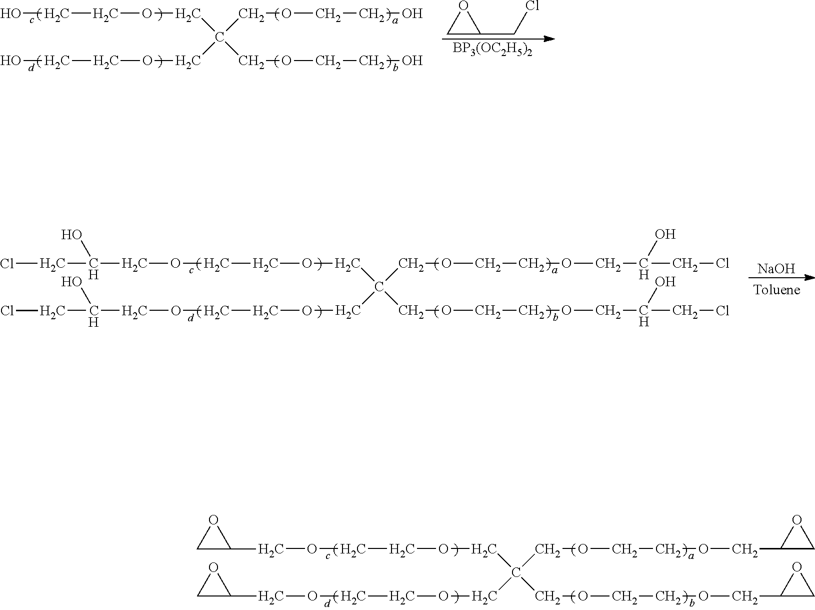

wherein, 1≤a≤15, 1≤b≤15, 1≤c≤15, 1≤d≤15, 4≤a+b+c+d≤40.

The preparation method of aminosilane modified tackifier described in the following examples is as follows:
(1) weighing a certain amount of quaternary polyether tetraol (PP150), heating to 110° C. for vacuum dehydration for 40 minutes and then cooling to room temperature with dry nitrogen gas; adding catalyst BF₃O(C₂H₅)₂ (boron trifluoride ether complex), with a rate of BF₃O(C₂H₅)₂:PP150=1:120 (by mass), and stirring evenly;
(2) raising the temperature to 60° C., and slowly adding epichlorohydrin dropwise using a constant pressure funnel within 2 hours while stirring; the ratio of epichlorohydrin to PP150 was 1:2.2 (by mass); then, keeping the temperature and reaction for 7 hours, and removing unreacted epichlorohydrin by evacuation;
(3) cooling down to 45° C., diluting the reaction solution with toluene, and adding solid NaOH in multiple portions within 2 hours with a ratio of NaOH:PP150=1:6.8 (by mass); keeping the reaction for 5 hours under heat preservation;
(4) vacuum filtering the reaction solution, collecting the filtrate with a separatory funnel, extracting the organic phase with a toluene, and finally washing with distilled water until neutral;
(5) placing the organic phase in a beaker, and placing the beaker in a 110° C. air drying oven for 8 hours to remove the solvent, and then placing it in a 110° C. vacuum drying oven for 40 minutes to obtain a low viscosity polymer with good fluidity, namely epoxy terminated polyether.
(6) reacting the epoxy terminated polyether prepared in step (5) with an aminosilane coupling agent at a molar ratio of epoxy group to amino group of 1:1.2-1.5, under low speed stirring at 40° C. for 1 hour to obtain a multi-claw aminosilane modified tackifier with multiple hydrolyzable reactive groups.

The reaction formulas involved in the preparation of aminosilane modified tackifiers are as follows:

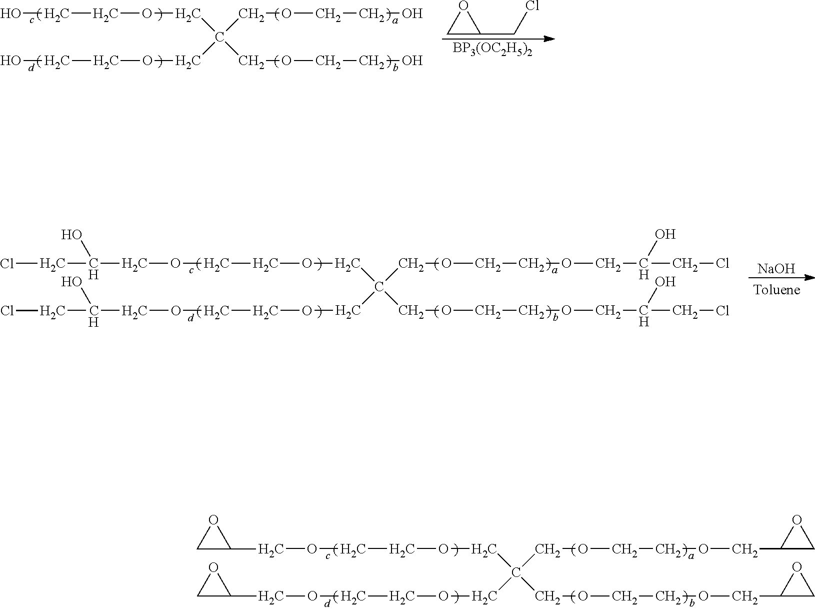

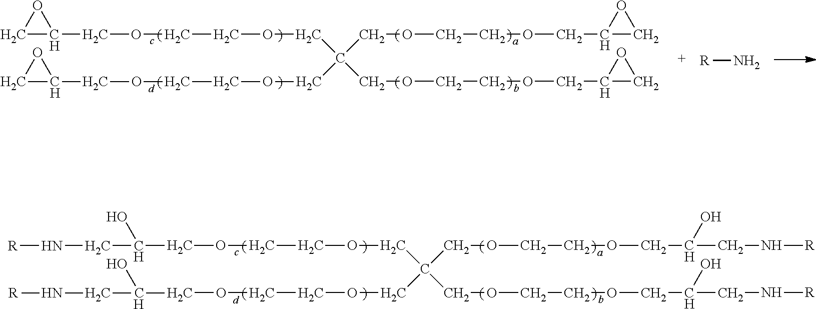

wherein, 1≤a≤15, 1≤b≤15, 1≤c≤15, 1≤d≤15, 4≤a+b+c+d≤40;
R—NH₂ is an aminosilane coupling agent, and is selected from at least one of γ-aminopropyltrimethoxysilane (KH540), γ-aminopropyltriethoxysilane (KH550), and 3-aminopropylmethyldimethoxysilane.

The following are specific implementation embodiments.

### Embodiment 1

The high-water-resistance and low-modulus silane modified polyether adhesive provided in this embodiment was prepared from the following components by weight:
15 parts of silane modified polyether polymer
5 parts of aminosilane modified tackifier
33.9 parts of nano-active calcium carbonate
40 parts of dibutyl phthalate
3 parts of polyamide wax
3 parts of vinyl triethoxysilane
0.1 part of dibutyltin dilaurate.

The structural formula of the silane modified polymether polymer is:

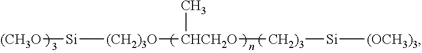

with a viscosity of 82 Pa·s at 25° C.

The aminosilane modified tackifier adopted KH540 as reaction end capping, i.e, R—NH₂ was KH540; the molar ratio of epoxy group to amino group was 1:1.2.

The nuclear magnetic resonance hydrogen spectrum (deuterated chloroform, ppm) of the aminosilane modified adhesive obtained in this embodiment showed four N—H peaks with chemical shifts between 3.6 ppm and 3.8 ppm, four-OH peaks with chemical shifts between 5.3 ppm and 5.4 ppm, multiple Si—OCH₃ peaks with chemical shifts between 3.5 ppm and 3.6 ppm, multiple methylene peaks with chemical shifts between 1.3 ppm and 1.4 ppm, and multiple H₂C—O—CH₂— peaks with chemical shifts between 3.54 ppm and 3.63 ppm; FT-IR spectroscopy analysis of the obtained aminosilane modified tackifier revealed characteristic absorption peaks at 3350 cm⁻¹ (—NH—), 1296 cm⁻¹ (N—C), 1250 cm⁻¹ (C—O), and 3328 cm⁻¹ (—OH), as well as stretching vibration absorption peaks at 1100 cm⁻¹ and 1080 cm⁻¹ (Si—O, C—O). The structural formula of the aminosilane modified tackifier obtained in this embodiment was as follows:

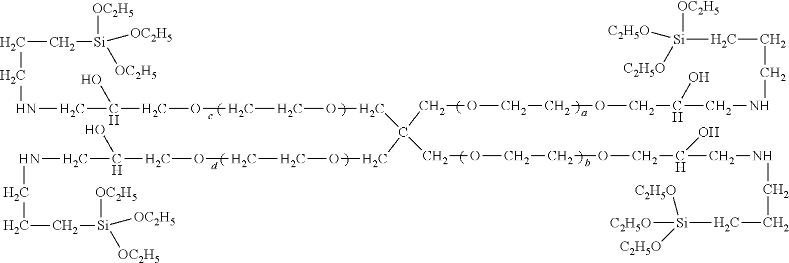

wherein, 1≤a≤15, 1≤b≤15, 1≤c≤15, 1≤d≤15, 4≤a+b+c+d≤40.

The method of preparing high-water-resistance and low-modulus silane modified polyether adhesive provided in this embodiment included the following steps:

mixing and stirring the silane modified polyether polymer, reinforcing filler (nano-active calcium carbonate), thixotropic agent (polyamide wax), and plasticizer (dibutyl phthalate) evenly for 50 minutes, then adding a water removal agent (vinyl triethoxysilane) and stirring for 20 minutes; adding aminosilane modified tackifier and catalyst (dibutyltin dilaurate) and stirring for 30 minutes under a vacuum condition of −0.09 MPa to −0.1 MPa to obtain the high-water-resistance and low-modulus silane modified polyether adhesive.

### Embodiment 2

The high-water-resistance and low-modulus silane modified polyether adhesive provided in this embodiment was prepared from the following components by weight:
25 parts of silane modified polyether polymer
4 parts of aminosilane modified tackifier
25 parts of nano-active calcium carbonate
20 parts of heavy calcium carbonate
20 parts of dioctyl phthalate
2 parts of polyamide wax
2.5 parts of vinyl trimethoxysilane
1.5 parts of dioctyltin diacetate.

The structural formula of the silane modified polyether polymer was:

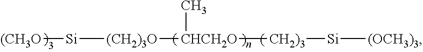

wherein, 20 parts of polymer with a viscosity of 8 Pa·s at 25° C. and 5 parts of polymer with a viscosity of 82 Pa·s.

The aminosilane modified tackifier adopted KH550 as reaction end capping, i.e, R—NH₂ was KH550; the molar ratio of epoxy group to amino group was 1:1.5.

The nuclear magnetic resonance hydrogen spectrum (deuterated chloroform, ppm) of the aminosilane modified adhesive obtained in this embodiment showed four N—H peaks with chemical shifts between 3.6 ppm and 3.8 ppm, four-OH peaks with chemical shifts between 5.3 ppm and 5.4 ppm, multiple Si—OC₂H₅ peaks with chemical shifts between 3.8 ppm and 4.0 ppm, and multiple H₂C—O—CH₂— peaks with chemical shifts between 3.54 ppm and 3.63 ppm; FT-IR spectroscopy analysis of the obtained aminosilane modified tackifier revealed characteristic absorption peaks at 3350 cm⁻¹ (—NH—), 1296 cm⁻¹ (N—C), 1250 cm⁻¹ (C—O), and 3350 cm⁻¹ (—OH), as well as stretching vibration absorption peaks at 1094 cm⁻¹ and 1080 cm⁻¹ (Si—O, C—O). The structural formula of the aminosilane modified tackifier obtained in this embodiment was as follows:

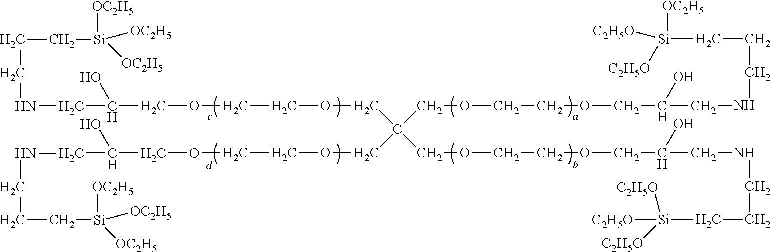

wherein, 1≤a≤15, 1≤b≤15, 1≤c≤15, 1≤d≤15, 4≤a+b+c+d≤40.

The method of preparing high-water-resistance and low-modulus silane modified polyether adhesive provided in this embodiment included the following steps:

mixing and stirring the silane modified polyether polymer, reinforcing filler (nano-active calcium carbonate and heavy calcium carbonate), thixotropic agent (polyamide wax), and plasticizer (dibutyltin dilaurate) evenly for 60 minutes, then adding a water removal agent (vinyl trimethoxysilane) and stirring for 20 minutes; adding aminosilane modified tackifier and catalyst (dioctyltin diacetate) and stirring for 40 minutes under a vacuum condition of −0.09 MPa to −0.1 MPa to obtain the high-water-resistance and low-modulus silane modified polyether adhesive.

### Embodiment 3

The high-water-resistance and low-modulus silane modified polyether adhesive provided in this embodiment was prepared from the following components by weight:
33 parts of silane modified polyether polymer
3 parts of aminosilane modified tackifier
15 parts of nano-active calcium carbonate
20 parts of silicon micro powder
20 parts of Diisodecyl adipate
5 parts of polyamide wax
2 parts of vinyl trimethoxysilane
2 parts of di-n-butylbis (acetylacetonate) tin.

The structural formula of the silane modified polymether polymer was:

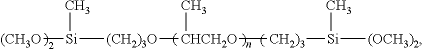

with a viscosity of 15 Pa·s at 25° C.

The aminosilane modified tackifier adopted 3-aminopropylmethyldimethoxysilane as reaction end capping, i.e, R—NH₂ was 3-aminopropylmethyldimethoxysilane; the molar ratio of epoxy group to amino group was 1:1.35.

The nuclear magnetic resonance hydrogen spectrum (deuterated chloroform, ppm) of the aminosilane modified adhesive obtained in this embodiment showed four N—H peaks with chemical shifts between 3.6 ppm and 3.8 ppm, four-OH peaks with chemical shifts between 5.3 ppm and 5.4 ppm, multiple Si—OCH₃ peaks with chemical shifts between 3.5 ppm and 3.6 ppm, multiple methylene peaks with chemical shifts between 1.3 ppm and 1.4 ppm, multiple —H₂C—O—CH₂— peaks with chemical shifts between 3.54 ppm and 3.63 ppm and four —CH₃ peaks with chemical shifts between 0.13 ppm and 0.14 ppm; FT-IR spectroscopy analysis of the obtained aminosilane modified tackifier revealed characteristic absorption peaks at 3350 cm⁻¹ (—NH—), 1296 cm⁻¹ (N—C), 1250 cm⁻¹ (C—O), 3345 cm⁻¹ (—OH), and 2962 cm⁻¹ (CH₃) as well as stretching vibration absorption peaks at 1100 cm⁻¹ and 1080 cm⁻¹ (Si—O, C—O). The structural formula of the aminosilane modified tackifier obtained in this embodiment was as follows:

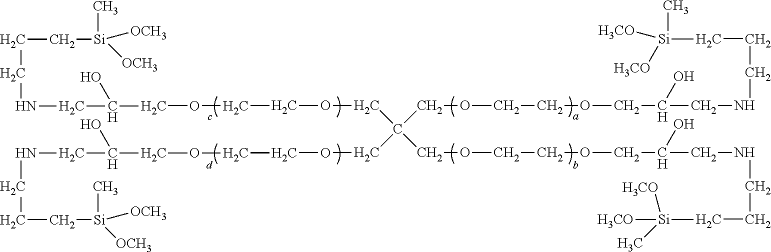

wherein, 1≤a≤15, 1≤b≤15, 1≤c≤15, 1≤d≤15, 4≤a+b+c+d≤40.

The method of preparing high-water-resistance and low-modulus silane modified polyether adhesive provided in this embodiment included the following steps:

mixing and stirring the silane modified polyether polymer, reinforcing filler (nano-active calcium carbonate and silicon micro powder), thixotropic agent (polyamide wax), and plasticizer (Diisodecyl adipate) evenly for 60 minutes, then adding a water removal agent (vinyl trimethoxysilane) and stirring for 20 minutes; adding aminosilane modified tackifier and catalyst (di-n-butylbis (acetylacetonate) tin) and stirring for 40 minutes under a vacuum condition of −0.09 MPa to −0.1 MPa to obtain the high-water-resistance and low-modulus silane modified polyether adhesive.

### Embodiment 4

The high-water-resistance and low-modulus silane modified polyether adhesive provided in this embodiment was prepared from the following components by weight:
45 parts of silane modified polyether polymer
2 parts of aminosilane modified tackifier
38 parts of nanoactive calcium carbonate
10 parts of cresyl diphenyl phosphate
2 parts of polyamide wax
2 parts of vinyltrimethoxysilane
1 part of di-n-butylbis (acetylacetonate) tin.

The structural formula of the silane modified polymether polymer was:

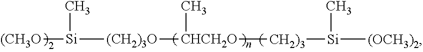

with a viscosity of 25 Pa·s at 25° C.

The aminosilane modified tackifier adopted 3-aminopropylmethyldimethoxysilane as reaction end capping, i.e, R—NH₂ was 3-aminopropylmethyldimethoxysilane; the molar ratio of epoxy group to amino group was 1:1.4. The structural formula of the aminosilane modified tackifier obtained was the same as in Embodiment 3.

The method of preparing high-water-resistance and low-modulus silane modified polyether adhesive provided in this embodiment included the following steps:

mixing and stirring the silane modified polyether polymer, reinforcing filler (nano-active calcium carbonate), thixotropic agent (polyamide wax), and plasticizer (cresyl diphenyl phosphate) evenly for 25 minutes, then adding a water removal agent (vinyltrimethoxysilane) and stirring evenly for 30 minutes; adding aminosilane modified tackifier and catalyst (di-n-butylbis (acetylacetonate) tin) and stirring for 50 minutes under a vacuum condition of −0.09 MPa to −0.1 MPa to obtain the high-water-resistance and low-modulus silane modified polyether adhesive.

### Embodiment 5

The high-water-resistance and low-modulus silane modified polyether adhesive provided in this embodiment was prepared from the following components by weight:
30 parts of silane modified polyether polymer
3 parts of aminosilane modified tackifier
43 parts of nano-active calcium carbonate
20 parts of PPG3000
1 part of polyamide wax
2.5 parts of vinylmethyldimethoxysilane
0.5 part of di-n-butylbis (acetylacetonate) tin.

The structural formula of the silane modified polymether polymer was:

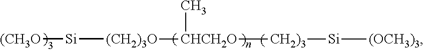

with a viscosity of 20 Pa·s at 25° C.

The aminosilane modified tackifier adopted KH550 as reaction end capping, i.e, R—NH₂ was KH550; the molar ratio of epoxy group to amino group was 1:1.25. The structural formula of the aminosilane modified tackifier obtained was the same as in Embodiment 2.

The method of preparing high-water-resistance and low-modulus silane modified polyether adhesive provided in this embodiment included the following steps:

mixing and stirring the silane modified polyether polymer, reinforcing filler (nano-active calcium carbonate), thixotropic agent (polyamide wax), and plasticizer (PPG3000) evenly for 60 minutes, then adding a water removal agent (vinyl methyldimethoxysilane) and stirring for 15 minutes; adding aminosilane modified tackifier and catalyst (di-n-butylbis (acetylacetonate) tin) and stirring for 20 minutes under a vacuum condition of −0.09 MPa to −0.1 MPa to obtain the high-water-resistance and low-modulus silane modified polyether adhesive.

### Comparative Embodiment 1

The difference between this Comparative embodiment and Embodiment 4 is that 3-aminopropylmethyldimethoxysilane was used instead of the aminosilane modified tackifier in Embodiment 4, and the other components and preparation methods were the same as Embodiment 4. Specifically, as follows:

The high-water-resistance and low-modulus silane modified polyether adhesive provided in this Comparative embodiment was prepared from the following components by weight:
45 parts of silane modified polyether polymer
2 parts of 3-aminopropylmethyldimethoxysilane
38 parts of nano-active calcium carbonate
10 parts of cresy diphenyl phosphate
2 parts of polyamide wax
2 parts of vinyltrimethoxysilane
1 part of di-n-butylbis (acetylacetonate) tin.

The method of preparing high-water-resistance and low-modulus silane modified polyether adhesive provided in this Comparative embodiment included the following steps:

mixing and stirring the silane modified polyether polymer, reinforcing filler (nano-active calcium carbonate), thixotropic agent (polyamide wax), and plasticizer (cresy diphenyl phosphate) evenly for 25 minutes, then adding a water removal agent (vinyltrimethoxysilane) and stirring evenly for 30 minutes; then adding 3-aminopropylmethyldimethoxysilane and catalyst (di-n-butylbis (acetylacetonate) tin) and stirring for 50 minutes under a vacuum condition of −0.09 MPa to −0.1 MPa to obtain the high-water-resistance and low-modulus silane modified polyether adhesive.

### Comparative Embodiment 2

The difference between this Comparative embodiment and Embodiment 5 is that γ-aminopropyltriethoxysilane (KH550) was used instead of the aminosilane modified tackifier in Embodiment 5, and the other components and preparation methods were the same as Embodiment 5. Specifically, as follows:

The high-water-resistance and low-modulus silane modified polyether adhesive provided in this Comparative embodiment was prepared from the following components by weight:
30 parts of silane modified polyether polymer
3 parts of γ-aminopropyltriethoxysilane (KH550)
43 parts of nano-active calcium carbonate
20 parts of PPG3000
1 part of polyamide wax
2.5 parts of vinylmethyldimethoxysilane
0.5 part of di-n-butylbis (acetylacetonate).

The method of preparing high-water-resistance and low-modulus silane modified polyether adhesive provided in this Comparative embodiment included the following steps:

mixing and stirring the silane modified polyether polymer, reinforcing filler (nano-active calcium carbonate), thixotropic agent (polyamide wax), and plasticizer (PPG3000) evenly for 60 minutes, then adding a water removal agent (vinylmethyldimethoxysilane) and stirring for 15 minutes; adding KH550 and catalyst (di-n-butylbis (acetylacetonate) tin) and stirring for 20 minutes under a vacuum condition of −0.09 MPa to −0.1 MPa to obtain the high-water-resistance and low-modulus silane modified polyether adhesive.

### Comparative Embodiment 3

The difference between this Comparative embodiment and Embodiment 5 is that epoxy terminated polyether was used instead of the aminosilane modified tackifier in Embodiment 5, and the other components and preparation methods were the same as Embodiment 5. Specifically, as follows:

The high-water-resistance and low-modulus silane modified polyether adhesive provided in this Comparative embodiment was prepared from the following components by weight:
30 parts of silane modified polyether polymer
3 parts of epoxy terminated polyether
43 parts of nano-active calcium carbonate
20 parts of PPG3000
1 part of polyamide wax
2.5 parts of vinylmethyldimethoxysilane
0.5 part of di-n-butylbis (acetylacetonate) tin.

The structural formula of the silane modified polymether polymer was:

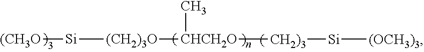

with a viscosity of 20 Pa·s.

The structural formula of the epoxy terminated polyether was:

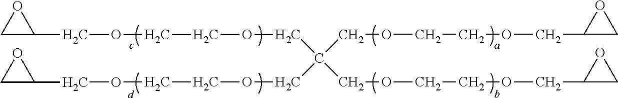

wherein, 1≤a≤15, 1≤b≤15, 1≤c≤15, 1≤d≤15, 4≤a+b+c+d≤40.

The method of preparing high-water-resistance and low-modulus silane modified polyether adhesive provided in this Comparative embodiment included the following steps:

mixing and stirring the silane modified polyether polymer, reinforcing filler (nano-active calcium carbonate), thixotropic agent (polyamide wax), and plasticizer (PPG3000) evenly for 60 minutes, then adding a water removal agent (vinylmethyldimethoxysilane) and stirring for 15 minutes; adding epoxy terminated polyether and catalyst (di-n-butylbis (acetylacetonate) tin) and stirring for 20 minutes under a vacuum condition of −0.09 MPa to −0.1 MPa to obtain the high-water-resistance and low-modulus silane modified polyether adhesive.

### Comparative Embodiment 4

The difference between this Comparative embodiment and Embodiment 5 is that γ-aminopropyltriethoxysilane (KH550) and epoxy terminated polyether was used instead of the aminosilane modified tackifier in Embodiment 5, and the other components and preparation methods were the same as Embodiment 5. Specifically, as follows:

The high-water-resistance and low-modulus silane modified polyether adhesive provided in this Comparative embodiment was prepared from the following components by weight:
30 parts of silane modified polyether polymer
0.7 part of γ-aminopropyltriethoxysilane (KH550)
2.3 parts of epoxy terminated polyether
43 parts of nano-active calcium carbonate
20 parts of PPG3000
1 part of polyamide wax
2.5 parts of vinylmethyldimethoxysilane
0.5 part of di-n-butylbis (acetylacetonate) tin.

The structural formula of the silane modified polymether polymer was:

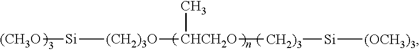

with a viscosity of 20 Pa·s.

The structural formula of the epoxy terminated polyether was:

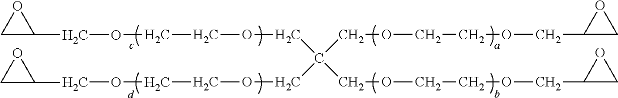

wherein, 1≤a≤15, 1≤b≤15, 1≤e≤15, 1≤d≤15, 4≤a+b+c+d≤40.

The method of preparing high-water-resistance and low-modulus silane modified polyether adhesive provided in this Comparative embodiment included the following steps:

mixing and stirring the silane modified polyether polymer, reinforcing filler (nano-active calcium carbonate), thixotropic agent (polyamide wax), and plasticizer (PPG3000) evenly for 60 minutes, then adding a water removal agent (vinylmethyldimethoxysilane) and stirring for 15 minutes; adding γ-aminopropyltriethoxysilane (KH550), epoxy terminated polyether and catalyst (di-n-butylbis (acetylacetonate) tin) and stirring for 20 minutes under a vacuum condition of −0.09 MPa to −0.1 MPa to obtain the high-water-resistance and low-modulus silane modified polyether adhesive.

In this Comparative embodiment, due to the reaction between γ-aminopropyltriethoxysilane (KH550) and epoxy terminated polyether during the preparation, the adhesive material partially agglomerated and difficult to disperse, resulting in poor appearance, storage, and construction performance of the sealant.

### Comparative Embodiment 5

25 LM silane modified polyether adhesive produced by a certain company on the market was selected and used.

The performances of the silane modified polyether adhesive prepared in Embodiments 1-5 and Comparative embodiments 1-4, and the silane modified polyether adhesive prepared in Comparative embodiment 5 were tested using the following methods:

Displacement capacity was tested and graded according to GB/T 22083-2008 standard.

The elastic recovery rate was tested according to the GB/T 13477.17-2017 standard.

The tensile modulus was tested according to the GB/T 13477.8-2017 standard.

The tensile properties at maintained extension was tested according to the GB/T 13477.8-2017 standard.

The adhesion after cold drawing and hot pressing was tested according to the GB/T 13477.13-2017 standard.

The tensile properties at maintained extension after water-soaking (4-day) was tested according to the GB/T 13477.11-2017 standard, and the water-soaking time was 4 days. After the experiment was completed, the specimen was checked according to 7.1 of GB/T 22083-2008 and the specimen failure was evaluated according to 7.3.

The tensile properties at maintained extension after water-soaking (30-day) was tested according to the GB/T 13477.11-2017 standard, and the water-soaking time was 30 days. After the experiment was completed, the specimen was checked according to 7.1 of GB/T 22083-2008 and the specimen failure was evaluated according to 7.3.

The tensile properties at maintained extension after water-soaking (60-day) was tested according to the GB/T 13477.11-2017 standard, and the water-soaking time was 60 days. After the experiment was completed, the specimen was checked according to 7.1 of GB/T 22083-2008 and the specimen failure was evaluated according to 7.3.

The tensile properties at maintained extension of after water-soaking (180-day) was tested according to the GB/T 13477.11-2017 standard, and the water-soaking time was 180 days. After the experiment was completed, the specimen was checked according to 7.1 of GB/T 22083-2008 and the specimen failure was evaluated according to 7.3.

The test results are shown in Table 1.

TABLE 1

| | | | | | | | Compar- | Compar- | Compar- | Compar- | Compar- |
|---|---|---|---|---|---|---|---|---|---|---|---|
| | | | | | | | ative | ative | ative | ative | ative |
| | | Embodi- | Embodi- | Embodi- | Embodi- | Embodi- | embodi- | embodi- | embodi- | embodi- | embodi- |
| Project | | ment 1 | ment 2 | ment 3 | ment 4 | ment 5 | ment 1 | ment 2 | ment 3 | ment 4 | ment 5 |
| Displacement | | 50 | 50 | 50 | 50 | 50 | 25 | 25 | 25 | / | 25 |
| Capability(%) | | | | | | | | | | | |
| Elasticity recovery rate (%) | | 80 | 83 | 84 | 83 | 85 | 72 | 75 | 73 | / | 73 |
| Tensile strength (MPa) | | 0.73 | 0.89 | 0.85 | 0.79 | 0.96 | 0.63 | 0.68 | 0.57 | 0.21 | 0.59 |
| Elongation at break (%) | | 683 | 709 | 754 | 722 | 785 | 521 | 545 | 510 | 63 | 423 |
| Tensile | 23° C. | 0.29 | 0.31 | 0.30 | 0.30 | 0.28 | 0.27 | 0.26 | 0.26 | / | 0.28 |
| modulus (MPa) | −20° C. | 0.30 | 0.32 | 0.31 | 0.31 | 0.29 | 0.28 | 0.27 | 0.26 | / | 0.30 |

| | | | | | | | | | | |
|---|---|---|---|---|---|---|---|---|---|---|
| tensile properties at | No | No | No | No | No | No | No | No | Damaged | No |
| maintained extension | damage | damage | damage | damage | damage | damage | damage | damage | | damage |
| Adhesion after cold | No | No | No | No | No | No | No | No | Damaged | No |
| drawing and hot pressing | damage | damage | damage | damage | damage | damage | damage | damage | | damage |
| tensile properties at | No | No | No | No | No | No | No | No | Damaged | No |
| maintained extension after | damage | damage | damage | damage | damage | damage | damage | damage | | damage |
| water-soaking (4-day) | | | | | | | | | | |
| tensile properties at | No | No | No | No | No | No | No | Damaged | Damaged | Damaged |
| maintained extension after | damage | damage | damage | damage | damage | damage | damage | | | |
| water-soaking (30-day) | | | | | | | | | | |
| tensile properties at | No | No | No | No | No | Damaged | Damaged | Damaged | Damaged | Damaged |
| maintained extension of | damage | damage | damage | damage | damage | | | | | |
| after immersion (60-day) | | | | | | | | | | |
| tensile properties at | No | No | No | No | No | Damaged | Damaged | Damaged | Damaged | Damaged |
| maintained extension after | damage | damage | damage | damage | damage | | | | | |
| water-soaking (180-day) | | | | | | | | | | |
| Mass loss (%) | 1 | 1 | 1 | 1 | 1 | 1 | 1 | 1 | 1 | 1 |
| Flowability/slump (mm) | 0 | 0 | 0 | 0 | 0 | 1 | 1 | 1 | 1 | 1 |

It can be seen from the results in Table 1 that the silane modified polyether adhesives in Embodiments 1 to 5 prepared by using the aminosilane modified tackifier synthesized by the present disclosure all have very high displacement capability, reaching the highest level of 50 LM in the current standard. However, in Comparative embodiment 4, due to the reaction between γ-aminopropyltriethoxysilane (KH550) and epoxy terminated polyether during the preparation of the sealant, the adhesive material partially agglomerated, resulting in poor appearance, storage, and construction properties of the sealant. After the test specimens were barely made, the mechanical tensile strength of the sample was only 0.21 MPa, and both tensile properties at maintained extension and water-soaking adhesion were damaged, which could hardly meet the adhesive sealant function of conventional sealants. The displacement capability of the silane modified polyether adhesives prepared in other Comparative embodiments was only 25 LM. The elastic recovery rate, tensile strength, and elongation at break of the silane modified polyether adhesives in Embodiments 1 to 5 were superior to those in Comparative embodiments 1 to 5. The tensile modulus of the silane modified polyether adhesives in Embodiments 1 to 5 at 23° C. and −20° C. were less than 0.4 MPa, which meets the modulus requirements of low-modulus sealants. The silane modified polyether adhesives of Embodiments 1 to 5 showed no damage to their tensile adhesion after being immersed in water for 180 days, while the silane modified polyether adhesives of Comparative Embodiments 1 to 5 showed damage to their tensile properties at maintained extension after being immersed in water for 60 days. The silane modified polyether adhesives in Comparative Embodiments 3 to which only epoxy terminated polyethers were added, and the commercially available silane-modified polyether adhesives of Comparative Embodiments 5, showed damage to their tensile properties at maintained extension after being immersed in water for 30 days. It is shown that the aminosilane modified tackifier synthesized by the present disclosure significantly improved the water-resistance of silane modified polyether adhesive, and also enhanced the comprehensive properties of silane modified polyether adhesive, such as displacement capacity, elastic recovery rate, and cohesive strength, etc. The high-water-resistance and low-modulus silane modified polyether adhesive prepared by the present disclosure is used as the waterproof sealant for prefabricated buildings, and it has good durability and can better ensure the long-term waterproof sealing effect of prefabricated buildings.

The technical features of the embodiments above can be combined arbitrarily. To simplify the description, all possible combinations of the technical features of the embodiments above are not described. However, as long as there is no contradiction in the combination of these technical features, they should be considered to be within the scope of the specification.

The embodiments above merely express several implementations of the present disclosure. The descriptions of the embodiments are relatively specific and detailed, but may not therefore be construed as the limitation on the patent scope of the present disclosure. It should be noted that a person of ordinary skill in the art may further make several variations and improvements without departing from the concept of the present disclosure. These variations and improvements all fall within the protection scope of the present disclosure. Therefore, the patent protection scope of the present disclosure shall be defined by the appended claims.

What is claimed is:

1. An aminosilane modified tackifier, having a following structure: 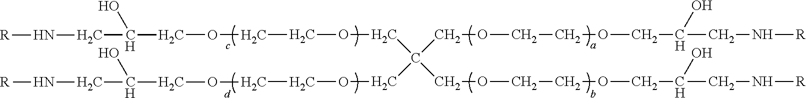
wherein 1≤a≤15, 1≤b≤15, 1≤c≤15, 1≤d≤15, 4≤a+b+c+d≤40;
R is a residue of an aminosilane coupling agent after removing an amino group.

2. The aminosilane modified tackifier according to claim 1, wherein the aminosilane coupling agent is selected from at least one of γ-aminopropyltrimethoxysilane, γ-aminopropyltriethoxysilane, and 3-aminopropylmethyldimethoxysilane.

3. An aminosilane modified tackifier, obtained by reacting an epoxy terminated polyether with an aminosilane coupling agent; the epoxy terminated polyether has a following structure: 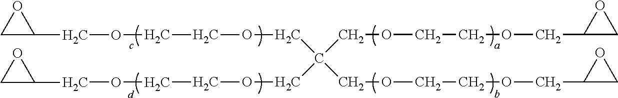
wherein 1≤a≤15, 1≤b≤15, 1≤c≤15, 1≤d≤15, 4≤a+b+c+d≤40.

4. The aminosilane modified tackifier according to claim 3, wherein the aminosilane coupling agent is selected from at least one of γ-aminopropyltrimethoxysilane, γ-aminopropyltriethoxysilane, and 3-aminopropylmethyldimethoxysilane.

5. The aminosilane modified tackifier according to claim 3, wherein a molar ratio of an epoxy group in the epoxy terminated polyether to an amino group in the aminosilane coupling agent is 1:1.2 to 1:1.5.

6. A method for preparing the aminosilane modified tackifier according to claim 3, comprising following steps:
reacting an epoxy terminated polyether with an aminosilane coupling agent at a reaction temperature of 25° C. to 50° C. for a reaction time of 40 minutes to 1.5 hours to obtain the aminosilane modified tackifier.

7. The method according to claim 6, wherein the reaction temperature is 35° C. to 45° C. and the reaction time is 55 minutes to 65 minutes.

8. A silane modified polyether adhesive, which is prepared from raw materials including a silane modified polyether polymer and the aminosilane modified tackifier according to claim 1.

9. The silane modified polyether adhesive according to claim 8, wherein a mass percentage of the aminosilane modified tackifier in the silane modified polyether adhesive is 1% to 5%.

10. The silane modified polyether adhesive according to claim 9, wherein, the silane modified polyether adhesive is prepared from raw materials comprising following components in parts by weight:
15 to 45 parts of the silane modified polyether polymer;
1 to 5 parts of the aminosilane modified tackifier;
20 to 60 parts of a reinforcing filler;
10 to 40 parts of a plasticizer;
0.5 to 5 parts of a thixotropic agent;
0.5 to 4 parts of a water removal agent; and
0.1 to 3 parts of a catalyst.

11. The silane modified polyether adhesive according to claim 10, wherein the silane modified polyether polymer is a polymer having a structure shown in formula (I) and/or formula (II): 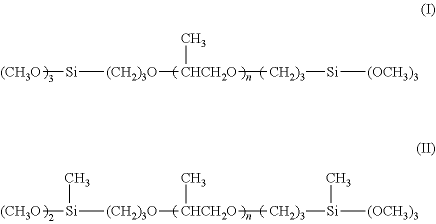
and/or,
the reinforcing filler is selected from at least one of nano-active calcium carbonate, silica micro-powder, and heavy calcium carbonate or talc powder; and/or,
the plasticizer is selected from at least one of dioctyl phthalate, diisodecyl phthalate, diisononyl phthalate, dibutyl phthalate, dioctyl adipate, diisodecyl adipate, dioctyl sebacate, diphenyl octyl phosphate, cresyl diphenyl phosphate, and polypropylene glycol; and/or,
the thixotropic agent is selected from at least one of polyamide wax, hydrogenated castor oil, organic bentonite, and gas-phase white carbon black; and/or,
the water removing agent is selected from at least one of vinyltrimethoxysilane, vinyltriethoxysilane, and vinylmethyldimethoxysilane; and/or,
the catalyst is selected from at least one of dibutyltin diacetate, dibutyltin dilaurate, dioctyltin diacetate, stannous octoate, and di-n-butylbis (acetylacetonate)-tin.

12. The silane modified polyether adhesive according to claim 11, wherein the silane modified polyether polymer has a viscosity of 6 Pa·s to 82 Pa·s at 25° C.

13. The silane modified polyether adhesive according to claim 11, wherein the silane modified polyether adhesive is prepared from the raw materials comprising the following components in parts by weight:
28 to 32 parts of the silane modified polyether polymer;
2.5 to 3.5 parts of the aminosilane modified tackifier;
40 to 46 parts of nano-active calcium carbonate;
18 to 22 parts of PPG3000;
0.8 to 1.2 parts of polyamide wax;
2 to 3 parts of vinylmethyldimethoxysilane; and
0.2 to 1 part of di-n-butylbis (acetylacetonate) tin;
a structural formula of the silane modified polyether polymer is: 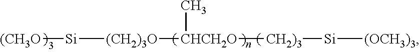
and its viscosity at 25° C. is 20 Pa·s;
a structural formula of the aminosilane modified tackifier is: 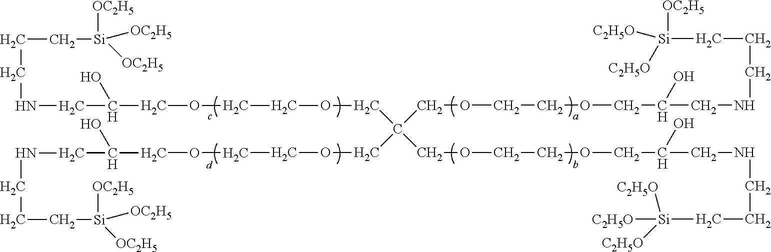
wherein, 1≤a≤15, 1≤b≤15, 1≤c≤15, 1≤d≤15,4≤a+b+c+d≤40.

14. A method for preparing the silane modified polyether adhesive according to claim 10, comprising following steps:
mixing and stirring the silane modified polyether polymer, the reinforcing filler, the thixotropic agent, and the plasticizer evenly, then adding the water removal agent, stirring evenly, and then adding the aminosilane modified tackifier and the catalyst, stirring evenly under a vacuum condition to obtain the silane modified polyether adhesive.
